(19) United States
(12) Patent Application Publication
(10) Pub. No.: US 2012/0323500 A1
(43) Pub. Date: Dec. 20, 2012

(54) APPARATUSES FOR MONITORING POWER TONG OPERATION

(75) Inventor: Dave PREFONTAINE, Blackfalds (CA)

(73) Assignee: Alberta Custom Technologies Ltd., Red Deer (CA)

(21) Appl. No.: 13/164,484

(22) Filed: Jun. 20, 2011

(51) Int. Cl. G06F 19/00; G01L 3/02

(52) U.S. Cl. 702/41

(57) ABSTRACT

Apparatuses for monitoring power tong operation are disclosed. The apparatus comprising: a sealed enclosure housing a computer and a battery; a torque sensor connected to send signals to the computer; and a turns counter connected to send signals to the computer; in which the battery is connected to supply power to the computer, the torque sensor, and the turns counter. An external display may be connected to receive display signals from the computer. The computer may be a microcontroller with a central processing unit, a motherboard, and a memory unit.

### TECHNICAL FIELD

This document relates to apparatuses for monitoring power tong operation.

### BACKGROUND

Power tongs are used in well drilling to rotate a tubular section that is being threaded to or unthreaded from another tubular section. Simultaneously, a backup tong may be used to hold the other tubular section stationary. Tongs may be mounted in a frame or suspended from a rig.

Sensors are used to measure tong operation variables to determine the quality of an oilfield tubular threaded connection and prevent joint damage. One such variable is the torque between the tubular segments measured during the make-up operation. The degree and uniformity of torque generated when making-up a connection is most commonly used to predict the reliability of the connection. Other variables such as the number of turns during makeup or breakout may assist. Monitoring such variables aids to prevent damage to the joint due to over torqueing.

Power for some or most of the sensors and equipment generally comes from the rig itself. In addition, the tong operation process is a two man operation, with one technician monitoring sensory data during real time on a computer while a second technician operates the tong itself.

### SUMMARY

An apparatus for monitoring power tong operation is disclosed, the apparatus comprising: a sealed enclosure housing a computer and a battery; a torque sensor connected to send signals to the computer; and a turns counter connected to send signals to the computer; in which the battery is connected to supply power to the computer, the torque sensor, and the turns counter.

An apparatus for monitoring power tong operation is also disclosed, the apparatus comprising: a sealed enclosure housing a computer; a torque sensor connected to send signals to the computer; a turns counter connected to send signals to the computer; and an external display connected to receive display signals from the computer.

An apparatus for monitoring power tong operation is also disclosed, the apparatus comprising: a sealed enclosure housing a microcontroller with a central processing unit, a motherboard, and a memory unit; a torque sensor connected to send signals to the computer; a turns counter connected to send signals to the computer; and an external display connected to receive display signals from the computer.

A computer monitoring system is also disclosed that is designed to measure torque and turns applied to the pipe joints used in petroleum wells. An industrial grade computer is connected to several peripheral devices, and the data is collected as the pipe joints are screwed together using power tongs. The data is displayed for the operator, and recorded on an industrial grade computer. During real time or at any time after the operation, the data may be transmitted to another computer such as a PC where the data may be graphed and a report generated for later use.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a schematic illustrating an apparatus for monitoring power tong operation.

FIG. 2 is a schematic illustrating the components within the sealed enclosure of the apparatus of FIG. 1.

FIG. 3 is a schematic illustrating a microcontroller.

### DETAILED DESCRIPTION

Immaterial modifications may be made to the embodiments described here without departing from what is covered by the claims.

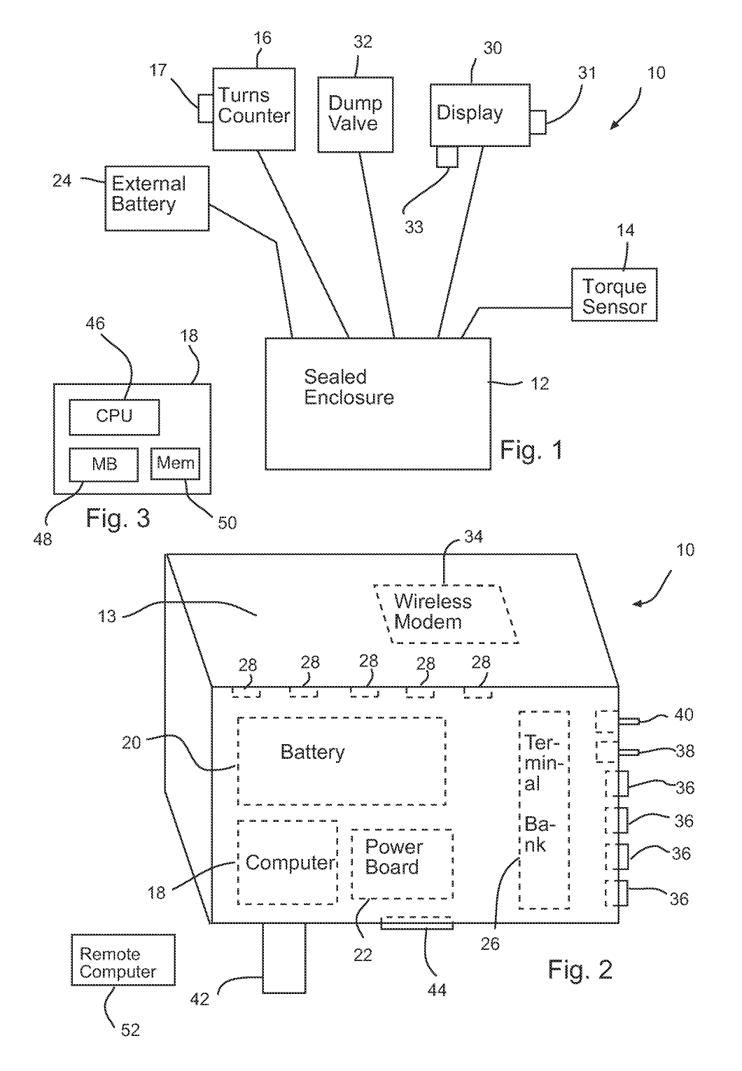

Referring to FIGS. 1 and 2, an apparatus 10 for monitoring power tong (not shown) operation is illustrated. Apparatus 10 may have a sealed enclosure 12 for housing various electronic components such as a computer 18 (FIG. 2) that may be required to be isolated from the potentially hazardous and explosive atmosphere found at the well site. Apparatus 10 may also include a torque sensor 14, and a turns counter 16 (FIG. 1). Torque sensor 14, commonly referred to as a load cell, is the device that actually measures the torque, sending signals such as electrical signals to the computer 18, which may then carry out process calculation. The turns counter 16 may be inserted into the drive train of the power tongs (not shown), for example using a magnetic mount 17 on the turns counter 16, and may be connected to send signals such as electrical pulses to the computer 18 when the tongs rotate. Computer 18 may also be connected to other peripheral devices such as external battery 24, an external display 30, and a dump valve 32.

In one embodiment, the sealed enclosure 12 houses a battery 20 (FIG. 2) connected to supply power to the computer 18, the torque sensor 14, and the turns counter 16. The battery 20, which may be a Li-ion battery pack, may supply power for the entire system and all peripheral devices. The battery 20 may be connected to supply power to each component through a power distribution board 22 located within the sealed enclosure 12. The power distribution board 22 may be a custom circuit board providing switching, regulation, and short circuit protection to a terminal bank 26, which may distribute power to the variety of peripheral devices such as turns counter 16 and torque sensor 16 via one or more suitable connectors 28. External battery 24 (FIG. 1), also called an auxiliary battery, may be connected to the power distribution board 22 for supplying power to the computer 18, the torque sensor 14, and the turns counter 16 when a power level of the internal battery 20 is diminished. External battery 24 allows tong operation monitoring to continue in the event that tong operations take longer than expected for example. The power distribution board 22 may perform switching of batteries if the external battery 24 is connected, regulate power to all subsystems, and may contain fusing for all power outputs, for example through connectors 28. Board 22 may also house a power transistor (not shown) used to switch dump valve 32 on and off when required. To save power, no mechanical relays may be used in an embodiment of apparatus 10.

For conventional monitoring systems that use the rig's power supply a power outage at the rig will stop operations, even if hydraulic power for the tongs is still available. In addition, for systems that use independent battery systems for each sensor or component, operations may still be obstructed or stopped should one of the batteries fail. Thus, the embodiments of the apparatus 10 disclosed herein that provide power to all components of the monitoring system using the same battery 20 or batteries located within the sealed enclosure 12 has the advantages of allowing tong operations to proceed in the event of a rig power outage, and providing a single source of power that may be used to reliably power all system components and may be easily replaced by an auxiliary power source 24 in the event of battery 20 drainage. In addition, use of a direct current (DC) low voltage power supply reduces safety issues that arise when using an alternating current (AC) rig power supply.

As described above, an external display 30 (FIG. 1) may be connected to receive display signals from the computer 18. Display 30 may thus display processed or unprocessed sensory data, for example in the form of a real time graph of torque and turns versus time. Display 30 may comprise a vacuum fluorescent display, which is advantageously operable down to temperatures as cold as −40 degrees Celsius. To assist in low temperature operation, tempered glass and LEXAN™ plastic (not shown) may cover display 30 to protect from moisture and scratches. External display 30 may further comprise a magnetic mount 31, which allows display 30 to be easily mounted on a material such as steel that is attracted or attractable to a magnet. External display 30 may also be mounted on a boom or stand (not shown), or mounted in other non-magnetic fashions directly to the tong, tong frame, or a suitable adjacent structure (not shown). External display 30 may further comprises a manual input 33 such as a pushbutton connected to send signals to the computer 18 for initiating recording of signal information from the torque sensor 14 and the turns counter 16.

In other tong monitoring devices, the display is located within a stainless steel enclosure that is also connected to all peripheral sensory equipment. However, because of the large number of cable connections to the enclosure, and the bulky nature of the enclosure, it is difficult or dangerous to manoeuver the display close enough for direct use by the tong operator when the system is in use. As a result, the general practice in the art with such systems is to provide one technician to operate the monitoring system while another technician operates the tongs. However, the apparatus 10 disclosed herein that provides an external display 30 connected to the sealed enclosure 12 allows the display 30 to be conveniently set up within the usable range of the tong operator, allowing the tong operator as a single individual to operate the tong and monitor sensory data at the same time. The magnetic mount 31 further assists the single individual to accomplish both of these tasks, by allowing the display 30 to be mounted at a suitable location on the power tong or power tong frame.

Manual input 33 further assists use of the apparatus 10 by a single individual, by allowing the tong operator a simple method of beginning to record data as a joint is made up or broken up. Computer 18 may be programmed to stop recording on reception of sensory data indicative of completion of joint makeup or breakout. For example, upon detection of torque levels surpassing the dump torque set point, which is an upper limit of torque manually entered into the system, recording may cease and the dump valve 32 triggered to shunt hydraulic power back to the tank (not shown) to prevent over torque of the pipe during makeup. The dump valve 32 is conventionally inserted into the hydraulic lines (not shown) running to the power tongs. Triggering the computer 18 to stop recording automatically may be advantageous given that such a practice eliminates the recording of redundant sensory data corresponding to data taken in the time interval, possibly of minutes or hours duration, between joint make up or breakout. Manual input 33 may also be provided elsewhere in apparatus 10, for example as a wireless control or separate wired external component connected to computer 18. A stop button (not shown) or other suitable controls for computer 18 may be located on display 30 or one a wireless control or separate wired external component connected to computer 18.

In one embodiment shown in FIG. 3, computer 18 is a microcontroller with a central processing unit (CPU) 40, a motherboard (MB) 48, and a memory unit (Mem) 50. Referring to FIG. 2, the microcontroller or computer 18 may be hard mounted to the sealed enclosure 12, for example with metal standoffs or a steel plate (not shown).

Known tong monitoring systems may use a PC such as a laptop mounted within a stainless steel box to operate and monitor tong sensors. However, the use of a conventional PC, including a standard LCD or LED display, touchscreen, and optionally mouse and keyboard inputs means that such systems are only operable down to about 0 degrees Celsius. By contrast, by providing a microcontroller with componentry only sufficient to receive, store, and display sensory data, the apparatus 10 disclosed herein has the advantage of allowing system operation in temperatures as cold as −40 Celsius. In addition, by further hard mounting the microcontroller to the sealed enclosure 12, the durability of the microcontroller is improved, and the life expectancy of the monitoring apparatus 10 increased, which is advantageous for systems used within the harsh environment of the wellhead.

As described above, to simplify operation of computer 18 no conventional manual inputs such as a keyboard, mouse, or touchscreen may be provided. Instead, one or more input switches 36 may be provided on sealed enclosure 12 for entering basic information required to operate apparatus 10. The switches 36, such as pushbutton switches as shown, may be connected directly to the computer 18 through the terminal bank 26, for switching digital states in the computer 18 and allowing for profile changes to be made and saved in non-volatile memory 50 (FIG. 3) in the computer 18. Interaction for this process may provided by the operator display 30. For example, a user may change load parameters such as the length of the tong arm, the torque upper limit for the dump valve 32, and a multiplier (K factor) to determine how many pulse counters determines one turn. In other cases apparatus 10 may auto-calibrate one or more of these or other parameters.

Computer 18 may perform functions such as gathering all sensor information, digital input information from the input switches 36 and operator display 32, monitoring the power level of the Li-ion battery 20, performing all process calculations, and logging process data to non-volatile memory 50 (FIG. 3). Because computer 18 may store sensor information, such information may then be used as a backup in case of external computer failure or may be transferred to an external computer after tong operations are complete.

The sealed enclosure 12 may further comprise a wireless modem 34 connected to the computer 18. Computer 18 may send process information to the operator display 30 and to an external computer 52 though either wireless modem 34 or an Ethernet port 44. Modem 34 may comprise a long range wireless modem and antenna 42. The wireless modem 34 may be wirelessly connected to a remote computer 52 for control or monitoring of power tong operation.

Typical wireless systems use conventional WI-FI™, which is a short range radio frequency system that is easily interfered with by generators and other equipment often present at a wellhead (not shown). In addition, reliable outdoor transmission distances are often limited to less than 100 m in the best of conditions. Thus, by using a long range wireless modem and an antenna, ranges of at least 200 m and up to 3 km and further are possible for data transmission to a tong monitoring or control station such as computer 52. In addition, by using an industrial grade wireless system such as a Freewave modem made by FreeWave Technologies of Boulder Colo., additional reliability may be obtained. Industrial grade wireless systems transmit at up to 300 times the power of conventional WI-FI™, at lower frequencies, and across numerous channels pre-scanned for interference.

The Ethernet connector 44 may be connected to the computer 18 and the wireless modem 34 with a y-bridge connector (not shown). To select wireless communication, a user may flip a wireless power switch 38 on the sealed enclosure 12 into the on position. For hardwired communication through the Ethernet connector 44, a user may flip the wireless power switch 38 off, and plug in an Ethernet cable (not shown) to the Ethernet connector 44.

All connections to sealed enclosure 12 may be adapted to ensure water resistance and to prevent entry of external fumes that would create a fire hazard within sealed enclosure 12. Thus, all connectors 28 may be mil spec connectors mounted to the sealed enclosure 12 with rubber gaskets (not shown). In addition, peripheral devices such as torque sensor 14, turns counter 16, dump valve 32, display 30, and external battery 24 may be connected to connectors 28 via hermetically sealed polyurethane jacketed cable (not shown). Enclosure 12 may have a hinged lid 13 for mounting modem 34 and for allowing access to the interior of enclosure 12 when required, for example for maintenance.

In the figures provided, not to scale, many connections between components have been omitted for simplicity but which may be needed in order for apparatus 10 to operate properly.

Some embodiments disclosed herein provide an apparatus 10 that is useful in operating temperatures of as cold as −40 degrees Celsius. Features such as use of a microcontroller, vacuum fluorescent display, and lithium ion battery assist in achieving this result.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. An apparatus for monitoring power tong operation, the apparatus comprising:
a sealed enclosure housing a computer and a battery;
a torque sensor connected to send signals to the computer; and
a turns counter connected to send signals to the computer;
in which the battery is connected to supply power to the computer, the torque sensor, and the turns counter.

2. The apparatus of claim 1 in which the battery is connected to supply power to the computer, the torque sensor, and the turns counter through a power distribution board within the sealed enclosure, and further comprising an external battery connected to the power distribution board for supplying power to the computer, the torque sensor, and the turns counter when a power level of the battery is diminished.

3. The apparatus of claim 1 in which the battery comprises a lithium ion battery.

4. The apparatus of claim 1 further comprising a dump valve connected to receive control signals from the computer, the battery being connected to supply power to the dump valve.

5. The apparatus of claim 1 further comprising an external display connected to receive display signals from the computer, the battery being connected to supply power to the external display.

6. The apparatus of claim 5 in which the external display comprises a magnetic mount.

7. The apparatus of claim 5 in which the external display comprises a vacuum fluorescent display.

8. The apparatus of claim 5 in which the external display further comprises a manual input connected to send signals to the computer for initiating recording of signal data from the torque sensor and the turns counter.

9. The apparatus of claim 1 in which the sealed enclosure further comprises a wireless modem connected to the computer.

10. The apparatus of claim 9 in which the wireless modem comprises a long range wireless modem and antenna.

11. The apparatus of claim 9 in which the wireless modem is wirelessly connected to a remote computer for control or monitoring of power tong operation.

12. The apparatus of claim 1 in which the torque sensor and the turns counter are connected to a power tong.

13. The apparatus of claim 1 in which the computer is a microcontroller with a central processing unit, a motherboard, and a memory unit.

14. The apparatus of claim 13 in which the microcontroller is hard mounted to the sealed enclosure.

15. An apparatus for monitoring power tong operation, the apparatus comprising:
a sealed enclosure housing a computer;
a torque sensor connected to send signals to the computer;
a turns counter connected to send signals to the computer; and
an external display connected to receive display signals from the computer.

16. The apparatus of claim 15 in which the external display further comprises a magnetic mount.

17. The apparatus of claim 15 in which the external display comprises a vacuum fluorescent display.

18. The apparatus of claim 15 in which the external display further comprises a manual input connected to send signals to the computer for initiating recording of signal information from the torque sensor and the turns counter.

19. An apparatus for monitoring power tong operation, the apparatus comprising:
a sealed enclosure housing a microcontroller with a central processing unit, a motherboard, and a memory unit;
a torque sensor connected to send signals to the computer;
a turns counter connected to send signals to the computer; and
an external display connected to receive display signals from the computer.

20. The apparatus of claim 19 in which the microcontroller is hard mounted to the sealed enclosure.
